(19) United States
(12) Patent Application Publication
(10) Pub. No.: US 2025/0174708 A1
(43) Pub. Date: May 29, 2025

(54) LITHIUM SECONDARY BATTERY

(71) Applicant: TOYOTA JIDOSHA KABUSHIKI KAISHA, Toyota-shi (JP)

(72) Inventor: Junko AMANO, Toyota-shi (JP)

(73) Assignee: TOYOTA JIDOSHA KABUSHIKI KAISHA, Toyota-shi (JP)

(21) Appl. No.: 18/915,686

(22) Filed: Oct. 15, 2024

(30) Foreign Application Priority Data
Nov. 27, 2023 (JP) 2023-199726

(51) Int. Cl. H01M 10/0525; H01M 4/66; H01M 4/70

(52) U.S. Cl. CPC H01M 10/0525; H01M 4/662; H01M 4/70

(57) ABSTRACT

A lithium secondary battery comprises a positive electrode, a separator, a negative electrode, and an electrolyte solution. The negative electrode includes a current collector. The current collector has a thickness from 10 to 20 μm. The current collector has a plurality of through holes. The through holes satisfy relationships of an expression (1) and an expression (2):

$$1.5 \leq B / A \leq 3. \qquad ( 1 )$$

$$0.05 \leq A \leq 0.18 \qquad ( 2 )$$

where a diameter of each of the through holes at a surface of the current collector is defined as a (mm), a center-to-center distance between each of the through holes and another through hole closest thereto is defined as b (mm), an average value of the diameter a (mm) is defined as A (mm), and an average value of the center-to-center distance b (mm) is defined as B (mm).

### CROSS REFERENCE TO RELATED APPLICATIONS

This nonprovisional application is based on Japanese Patent Application No. 2023-199726 filed on Nov. 27, 2023, with the Japan Patent Office, the entire contents of which are hereby incorporated by reference.

### BACKGROUND OF THE DISCLOSURE

### Field of the Disclosure

The present disclosure relates to a lithium secondary battery.

### Description of the Background Art

Japanese Patent Laying-Open No. 2019-160776 discloses forming a plurality of raised portions on a first surface and a second surface, respectively, of a negative electrode current collector.

### SUMMARY OF THE DISCLOSURE

In a lithium secondary battery that uses a lithium metal dissolution/deposition reaction (namely, a reaction of dissolution and deposition of lithium metal) as a reaction at the negative electrode, as disclosed by the above-mentioned reference document, lithium metal becomes deposited from the electrolyte solution during charging. And, during discharging, lithium metal dissolves into the electrolyte solution. The use of a dissolution/deposition reaction is expected to increase energy density. However, cycle endurance of lithium secondary batteries still has room for improvement.

An object of the present disclosure is to enhance cycle endurance of a lithium secondary battery.

Hereinafter, the technical configuration and effects of the present disclosure will be described. It should be noted that the action mechanism according to the present specification includes presumption. The action mechanism does not limit the technical scope of the present disclosure.

1. A lithium secondary battery comprises a positive electrode, a separator, a negative electrode, and an electrolyte solution. The lithium secondary battery is a battery that uses a lithium metal dissolution/deposition reaction as a reaction at the negative electrode. The negative electrode includes a current collector. The current collector has a thickness from 10 to 20 μm. The current collector has a plurality of through holes. The through holes satisfy relationships of an expression (1) and an expression (2):

$$1.5 \leq B / A \leq 3. \qquad ( 1 )$$

$$0.05 \leq A \leq 0.18 \qquad ( 2 )$$

where a diameter of each of the through holes at a surface of the current collector is defined as a (mm), a center-to-center distance between each of the through holes and another through hole closest thereto is defined as b (mm), an average value of the diameter a (mm) is defined as A (mm), and an average value of the center-to-center distance b (mm) is defined as B (mm).

In a lithium secondary battery that uses a lithium metal dissolution/deposition reaction as a reaction at the negative electrode, during charging, lithium metal may become deposited at a plurality of starting points on the negative electrode to form a plurality of deposits. The deposits may cause expansion of the negative electrode, potentially leading to degradation of capacity retention. Expansion of the negative electrode means an increase of the sum of the volume of the negative electrode and the volume of the deposited lithium metal. Also, as it grows and becomes larger, each of the deposits tends to partially or entirely fall into the electrolyte solution. The lithium metal thus fell may cause irreversible capacity loss. Due to the expansion of the negative electrode as well as due to an increase of lithium metal deposits falling into the electrolyte solution, capacity retention of the lithium secondary battery is degraded and cycle endurance is degraded.

For example, Japanese Patent Laying-Open No. 2019-160776 discloses forming a plurality of raised portions on a first surface and a second surface, respectively, of a negative electrode current collector to control lithium metal deposition. However, forming a plurality of raised portions on a first surface and a second surface, respectively, of a negative electrode current collector requires complex machining. In addition, because the plurality of raised portions are made of resin material, the surface of the raised portions does not serve as a starting point for lithium metal deposition. On the other hand, in the present disclosure, a current collector having a plurality of through holes is used for controlling lithium metal deposition. The interior wall of the plurality of through holes serves as a deposition starting point, and machining for forming such through holes is easy and simple.

According to the present disclosure, it is possible to enhance cycle endurance of a lithium secondary battery. This is made possible as a result of the current collector having a plurality of through holes and the plurality of through holes being arranged in such a manner to satisfy the above-mentioned expression (1) and the above-mentioned expression (2). More specifically, because the current collector has a plurality of through holes, lithium metal becomes deposited also on the interior wall of the plurality of through holes, so the number of deposition starting points is increased moderately. With the number of deposition starting points being moderately increased, the current density of the deposits is decreased, and thereby the deposits that became deposited at the starting points can grow in high density. In addition, with the deposits present in high density, falling of them is reduced. Furthermore, with the deposits present in high density and growing from starting points which are moderately close to one another, after they grow further to form a single continuous deposit, expansion of the negative electrode is reduced. It is conjectured that the growth of the deposits from the starting points which are moderately close to one another can be made possible as a result of the plurality of through holes satisfying the relationships of the above-mentioned expression (1) and the above-mentioned expression (2).

2. The lithium secondary battery according to “1” above may include the following configuration, for example. The current collector is a copper foil or a copper alloy foil.

3. The lithium secondary battery according to “1” or “2” above may include the following configuration, for example. An aperture rate of the surface of the current collector is from 5.0 to 35.0%.

When the aperture rate of the surface is not less than 5.0%, the number of starting points for lithium metal deposition is expected to be increased and the current density of the deposits that become deposited at the starting points is expected to be decreased. When the aperture rate of the surface is not more than 35.0%, it is expected that lithium metal becomes deposited at starting points which are moderately close to one another.

4. The lithium secondary battery according to any one of “1” to “3” above may include the following configuration, for example. An exposed area per 1 cm² of the surface of the current collector is from 0.86 to 0.99 cm².

5. In the lithium secondary battery according to “1” above, the current collector is a copper foil or a copper alloy foil, an aperture rate of the surface is from 5.0 to 35.0%, and an exposed area per 1 cm² of the surface is from 0.86 to 0.99 cm², for example.

6. A method of producing the lithium secondary battery according to “1” above comprises, for example: preparing the current collector; assembling the positive electrode, the separator, the negative electrode, and the electrolyte solution into a lithium secondary battery precursor; and charging the lithium secondary battery precursor to let lithium metal be deposited on the negative electrode.

Next, an embodiment of the present disclosure (which may also be simply called “the present embodiment” hereinafter) and an example of the present disclosure (which may also be simply called “the present example” hereinafter) will be described. It should be noted that neither the present embodiment nor the present example limits the technical scope of the present disclosure. The present embodiment and the present example are illustrative in any respect. The present embodiment and the present example are non-restrictive. The technical scope of the present disclosure encompasses any modifications within the meaning and the scope equivalent to the terms of the claims. For example, it is originally planned that certain configurations of the present embodiment and the present example can be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a conceptual view illustrating a lithium secondary battery according to the present embodiment.

FIG. 2 is a conceptual view illustrating an example of a current collector according to the present embodiment.

FIG. 3 is a conceptual view illustrating another example of a current collector according to the present embodiment.

FIG. 4 is a conceptual view illustrating the charging/discharging process that occurs near a current collector of a lithium secondary battery according to the present embodiment.

FIG. 5 is a first configuration example of a lithium secondary battery according to the present embodiment.

FIG. 6 is a second configuration example of a lithium secondary battery according to the present embodiment.

FIG. 7 is a third configuration example of a lithium secondary battery according to the present embodiment.

FIG. 8 is Table 1 that shows the pattern of arrangement of through holes of a current collector as well as evaluation results.

FIG. 9 is a graph showing discharged capacity retention at cycles for Nos. 1 to 5.

### DESCRIPTION OF THE PREFERRED EMBODIMENTS

### Description of Terms

A description will be provided for terms that are used in the present specification. Terms that are not described here may be described in the specification when the term is used.

Expressions such as “comprise”, “include”, and “have”, and other similar expressions (such as “be composed of”, for example) are open-ended expressions. In an open-ended expression, in addition to an essential component, an additional component may or may not be further included. The expression “consist of” is a closed-end expression. However, even when a closed-end expression is used, impurities present under ordinary circumstances as well as an additional element irrelevant to the technique according to the present disclosure are not excluded. The expression “consist essentially of” is a semiclosed-end expression. A semiclosed-end expression tolerates addition of an element that does not substantially affect the fundamental, novel features of the technique according to the present disclosure.

Expressions such as “may” and “can” are not intended to mean “must” (obligation) but rather mean “there is a possibility” (tolerance).

A singular form also includes its plural meaning, unless otherwise specified. For example, “a particle” may mean not only “one particle” but also “a plurality of particles (a particle group)” and “a group of particles (powder)”.

A numerical range such as “from m to n %” includes both the upper limit and the lower limit, unless otherwise specified. That is, “from m to n %” means a numerical range of “not less than m % and not more than n %”. Moreover, “not less than m % and not more than n %” includes “more than m % and less than n %”. “Not less than” and “not more than” are represented by an inequality symbol with an equality symbol, e.g., “≤”. “More than” and “less than” are represented by an inequality symbol without an equality symbol, e.g., “<”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

All the numerical values are regarded as being modified by the term “about”. The term “about” may mean ±5%, ±3%, ±1%, and/or the like, for example. Each numerical value may be an approximate value that can vary depending on the implementation configuration of the technique according to the present disclosure. Each numerical value may be expressed in significant figures. Unless otherwise specified, each measured value may be the average value obtained from multiple measurements performed. The number of measurements may be 3 or more, or may be 5 or more, or may be 10 or more. Generally, the greater the number of measurements is, the more reliable the average value is expected to be. Each measured value may be rounded off based on the number of the significant figures. Each measured value may include an error occurring due to an identification limit of the measurement apparatus, for example.

A stoichiometric composition formula represents a typical example of a compound. A compound may have a non-stoichiometric composition. For example, “Al₂O₃” is not limited to a compound where the ratio of the amount of substance (molar ratio) is “Al/O=2/3”. “Al₂O₃” represents a compound that includes Al and O in any composition ratio, unless otherwise specified. For example, the compound may be doped with a trace element. Some of Al and/or O may be replaced by another element.

“Derivative” refers to a compound that is derived from its original compound by at least one partial modification selected from the group consisting of substituent introduction, atom replacement, oxidation, reduction, and other chemical reactions. The position of modification may be one position, or may be a plurality of positions. “Substituent” may include, for example, at least one selected from the group consisting of alkyl group, alkenyl group, alkynyl group, cycloalkyl group, unsaturated cycloalkyl group, aromatic group, heterocyclic group, halogen atom (F, Cl, Br, I, etc.), OH group, SH group, CN group, SCN group, OCN group, nitro group, alkoxy group, unsaturated alkoxy group, amino group, alkylamino group, dialkylamino group, aryloxy group, acyl group, alkoxycarbonyl group, acyloxy group, aryloxycarbonyl group, acylamino group, alkoxycarbonylamino group, aryloxy carbonylamino group, sulfonylamino group, sulfamoyl group, carbamoyl group, alkylthio group, arylthio group, sulfonyl group, sulfinyl group, ureido group, phosphoramide group, sulfo group, carboxy group, hydroxamic acid group, sulfino group, hydrazino group, imino group, silyl group, and the like. These substituents may be further substituted. When there are two or more substituents, these substituents may be the same as one another or may be different from each other. A plurality of substituents may be bonded together to form a ring. A derivative of a polymer compound (a resin material) may also be called “a modified product”.

“Copolymer” includes at least one selected from the group consisting of unspecified-type, statistical-type, random-type, alternating-type, periodic-type, block-type, and graft-type.

“SOC (state of charge)” refers to the percentage of the charged capacity of the battery at a particular point in time relative to the full charge capacity of the battery.

“Lithium secondary battery” refers to a battery in which negative electrode reaction includes lithium metal dissolution/deposition reaction. For example, lithium metal dissolution/deposition reaction may be responsible for 1 to 100%, or 25 to 100%, or 50 to 100%, or 75 to 100% of the negative electrode capacity. The negative electrode capacity exhibits reversible capacity loss. For example, at an SOC from 1 to 100%, or from 1 to 75%, or from 1 to 50%, or from 1 to 25%, lithium metal may be deposited on the negative electrode. At an SOC of 0% (at a fully discharged state), lithium metal may be fully dissolved in the electrolyte solution. At an SOC of 0%, lithium metal may partially remain at the negative electrode.

Usually, lithium metal deposition in a lithium-ion secondary battery may cause irreversible capacity loss. For example, lithium metal deposition in a lithium-ion secondary battery is an unintended reaction. For example, lithium metal deposition in a lithium-ion secondary battery may occur under abnormal conditions, at the time of improper use, and/or the like.

In “an anode-free battery”, no lithium metal is present at the negative electrode before initial charging (after assembly and before first-time charging). An anode-free battery is assembled in a state where the negative electrode does not include lithium metal (a negative electrode active material). A lithium secondary battery thus assembled and before initial charging is also called “a lithium secondary battery precursor” in the present disclosure. At the time of initial charging, lithium is supplied from the positive electrode to the negative electrode, and thereby, for the first time, lithium metal becomes deposited on the negative electrode. In an anode-free battery, at a fully discharged state, lithium metal may be fully dissolved.

### <Lithium Secondary Battery>

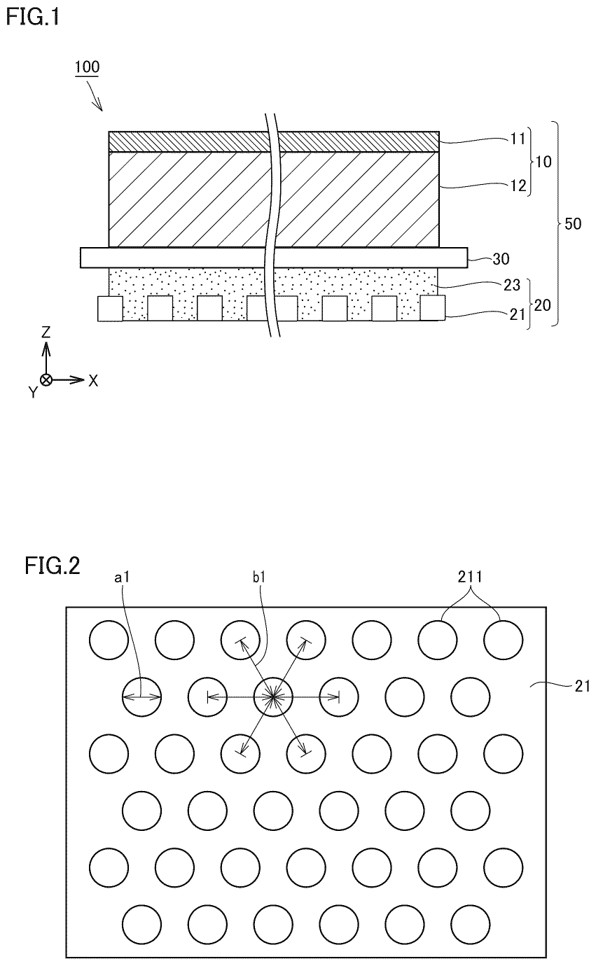

FIG. 1 is a conceptual view illustrating a lithium secondary battery according to the present embodiment. A battery 100 includes a power generation element 50 and an electrolyte solution (not illustrated).

### <Exterior Package>

Battery 100 may include an exterior package (not illustrated). The exterior package may accommodate power generation element 50 and an electrolyte solution. The exterior package may have any configuration. The exterior package may be a case made of metal, or may be a pouch made of a metal foil laminated film, for example. The case may have any shape. The case may be cylindrical, prismatic, flat, coin-shaped, and/or the like, for example. The exterior package may include Al and/or the like, for example. The exterior package may accommodate a single power generation element 50, or may accommodate a plurality of power generation elements 50, for example. The plurality of power generation elements 50 may form a series circuit, or may form a parallel circuit, for example. Inside the exterior package, the plurality of power generation elements 50 may be stacked in the thickness direction of battery 100.

### <Power Generation Element>

Power generation element 50 includes a positive electrode 10, a negative electrode 20, and a separator 30. Separator 30 is interposed between positive electrode 10 and negative electrode 20. Power generation element 50 may have any configuration. Power generation element 50 may have a bipolar structure, or may have a monopolar structure. For example, power generation element 50 may be a stack-type one. For example, positive electrode 10 and negative electrode 20 may be alternately stacked with separator 30 interposed between positive electrode 10 and negative electrode 20 to form power generation element 50. For example, separator 30 having a belt-like shape may be folded into a Z-shape, and at each turn of separator 30, positive electrode 10 and negative electrode 20 may be placed alternately. For example, power generation element 50 may be a wound-type one. For example, each of positive electrode 10, negative electrode 20, and separator 30 may have a belt-like shape. For example, positive electrode 10, separator 30, and negative electrode 20 may be stacked in this order to form a stack. The resulting stack may be wound spirally to form power generation element 50. After being wound, the wound power generation element 50 may be shaped into a flat form.

### <Negative Electrode>

Negative electrode 20 includes a current collector 21. At an SOC above 0%, negative electrode 20 further includes a Li metal layer 23 on current collector 21. As the SOC increases or decreases, the thickness of Li metal layer 23 also increases or decreases. Li metal layer 23 may have a configuration consisting of a plurality of deposits, or may have a configuration consisting of a single continuous deposit.

Current collector 21 is electrically conductive. Current collector 21 is capable of functioning as a current collector, and examples thereof include a foil, a film, and the like. The thickness of current collector 21 is from 10 to 20 μm, and, for example, it may be from 12 to 18 μm. The material of current collector 21 may be a conductive material such as metal, alloy, and the like, which is not particularly limited as long as it is neither lithium metal nor lithium alloy. Preferably, the conductive material is a material that does not react with lithium. The conductive material of this type may include at least one selected from the group consisting of copper (Cu), nickel (Ni), iron (Fe), zinc (Zn), lead (Pb), silver (Ag), and gold (Au), for example. Examples of the alloy include copper alloy, stainless steel (SUS), and the like. For example, current collector 21 is a copper foil or a copper alloy foil.

Current collector 21 has a plurality of through holes. The through holes satisfy the relationships of an expression (1) and an expression (2):

$$1.5 \leq B / A \leq 3. \qquad ( 1 )$$

$$0.05 \leq A \leq 0.18 \qquad ( 2 )$$

where the diameter of each of the through holes at the surface of the current collector is defined as a (mm), the center-to-center distance between each of the through holes and another through hole closest thereto is defined as b (mm), the average value of the diameter a (mm) is defined as A (mm), and the average value of the center-to-center distance b (mm) is defined as B (mm). The above-mentioned average value means an arithmetic mean.

The pattern of arrangement of the plurality of through holes is not particularly limited as long as it satisfies the above-mentioned expression (1) and the above-mentioned expression (2). The shape of each of the plurality of through holes at the surface is not particularly limited, and, for example, it is circular, elliptical, or rectangular. As for the diameter of the through hole, when the shape of the through hole at the surface is circular, it is the diameter of the circle, and when the shape is not circular, it is the diameter of a smallest circle that contains the surface shape. As for the center of the through hole, when the shape of the through hole at the surface is circular, it is the center of the circle, and when the shape is not circular, it is the center of a smallest circle that contains the surface shape. The diameter, a (mm), and the center-to-center distance, b (mm), of the through hole can be determined in an image taken by SEM.

Current collector 21 is not particularly limited as long as the pattern of arrangement of the plurality of through holes in a target region satisfies the above-mentioned expression (1) and the above-mentioned expression (2). The target region may be the entire surface of current collector 21, or may be a part of the surface.

For example, the pattern of arrangement of the plurality of through holes may satisfy the relationships of an expression (1a) and an expression (2a):

$$1.55 \leq B / A \leq 3. \qquad ( 1 a )$$

$$0.08 \leq A \leq 0 \text{.14} . \qquad ( 2 a )$$

On the surface of current collector 21, a negative electrode composite material layer may be formed. The negative electrode composite material layer is formed by, for example, applying a paste that contains a negative electrode active material such as a carbon material (such as graphite) and/or a Si material, to at least part of the surface of the negative electrode current collector. To the surface of current collector 21, metal coating may be applied. The metal coating may include at least one selected from the group consisting of magnesium (Mg), aluminum (Al), zinc (Zn), silver (Ag), gold (Au), platinum (Pt), and tin (Sn).

FIG. 2 is a conceptual view illustrating an example of a current collector according to the present embodiment. FIG. 2 schematically illustrates the upper surface of current collector 21 (one of its surfaces). Current collector 21 has a plurality of through holes 211. In the arrangement pattern illustrated in FIG. 2, for any through hole 211 except those positioned on the periphery, there are six other through holes 211 closest to one through hole 211. The shape of through hole 211 at the upper surface is circular. The plurality of through holes 211 are arranged so that their diameters are the same, which is a1 (mm), and the center-to-center distance between a through hole 211 and other through holes 211 closest thereto is uniform, which is b1 (mm). In the arrangement pattern illustrated in FIG. 2, the average value of the diameter of through holes 211, A (mm), is a1 (mm), and the average value of the center-to-center distance, B (mm), is b1 (mm).

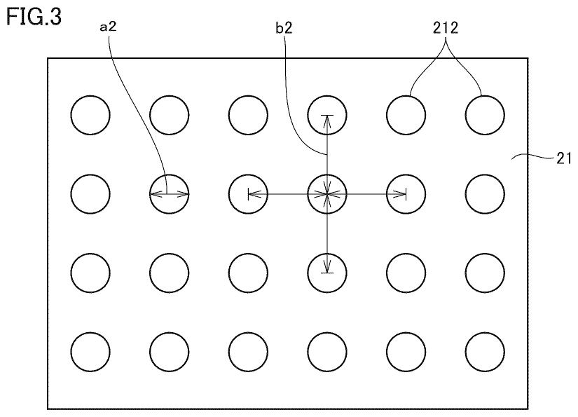

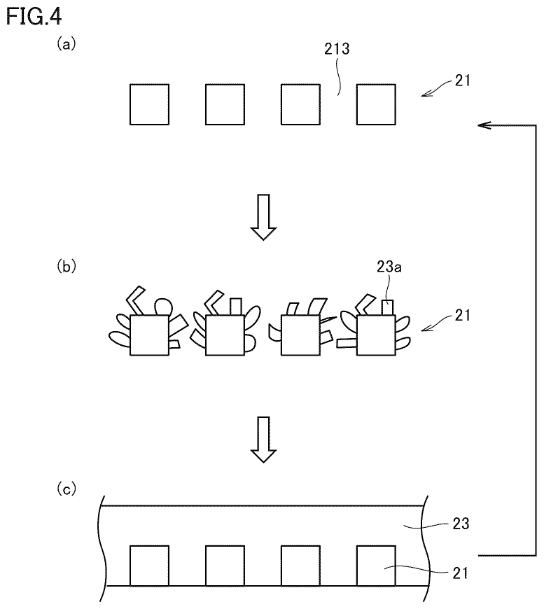

FIG. 3 is a conceptual view illustrating another example of the current collector according to the present embodiment, an example different from FIG. 2. FIG. 3 schematically illustrates the upper surface of current collector 21 (one of its surfaces). Current collector 21 has a plurality of through holes 212. In the arrangement pattern illustrated in FIG. 3, for any through hole 212 except those positioned on the periphery, there are four other through holes 212 closest to one through hole 212. The shape of through hole 212 at the upper surface is circular. The plurality of through holes 212 are arranged so that their diameters are the same, which is a2 (mm), and the center-to-center distance between a through hole 212 and other through holes 212 closest thereto is uniform, which is b2 (mm). In the arrangement pattern illustrated in FIG. 3, the average value of the diameter of through holes 212, A (mm), is a2 (mm), and the average value of the center-to-center distance, B (mm), is b2 (mm).

The aperture rate of one of the surfaces of current collector 21 according to the present embodiment is from 5.0 to 35.0%, for example, and it may be from 6.0 to 32.0%, or may be from 7.0 to 30.0%. The aperture rate of a surface means the ratio of the total area of the plurality of through holes at one of the surfaces of current collector 21 relative to the area of the surface. For example, in examples illustrated in FIG. 2 and FIG. 3, it means the ratio of the total area of the upper surface of current collector 21 occupied by through holes 211, 212 formed at current collector 21 relative to the area of the upper surface of current collector 21.

The exposed area (namely, the area of exposed surface) of current collector 21 according to the present embodiment per 1 cm² of the surface is from 0.86 to 0.99 cm², for example, and it may be from 0.87 to 0.98 cm². The exposed area herein means an area calculated by subtracting, from the area of one of the surfaces of current collector 21, the total area of the plurality of through holes at the surface, and then adding, to the resulting value, the area of the interior wall of the through holes; and the resultant is divided by the surface area of current collector 21 to obtain the exposed area per 1 cm² of the surface. The exposed surface herein refers to a surface that is intended to serve as the interface between the current collector and Li metal layer 23 when the latter is formed; and the exposed surface consists of the surface of current collector 21 that faces positive electrode 10 via separator 30 (excluding the surface of the through holes), as well as the interior wall of the through holes.

The method of machining to form the plurality of through holes at current collector 21 according to the present embodiment is not particularly limited, and electrical discharge machining, cutting, laser machining, and/or the like can be adopted for the forming.

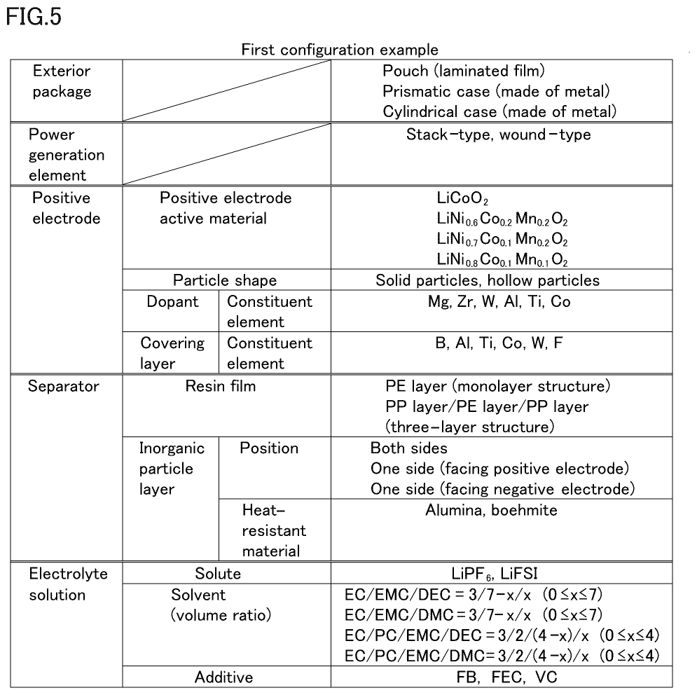

FIG. 4 is a conceptual view illustrating the charging/discharging process that occurs near the negative electrode of the lithium secondary battery according to the present embodiment. FIG. 4(a) illustrates the initial state. After the initial state, as charging of the lithium secondary battery proceeds, lithium metal becomes deposited at a plurality of starting points on current collector 21 to form deposits 23a, as illustrated in FIG. 4(b). Current collector 21 has a plurality of through holes 213, and the interior wall of the plurality of through holes 213 also serves as a starting point of formation of deposits 23a. As charging continues to proceed, deposits 23a deposited at and growing from different starting points form a single Li metal layer 23, as illustrated in FIG. 4(c). Then, during discharging of the lithium secondary battery, the metal lithium layer 23 becomes eluted. Li metal layer 23 may be a single deposit, or may consist of a plurality of deposits.

### <Positive Electrode>

Positive electrode 10 may be in sheet form, for example. Positive electrode 10 may include a positive electrode base material 11 and a positive electrode active material layer 12, for example. Positive electrode base material 11 is electrically conductive. Positive electrode base material 11 may function as a current collector. Positive electrode base material 11 supports positive electrode active material layer 12. Positive electrode base material 11 may be in sheet form, for example. Positive electrode base material 11 may have a thickness from 5 to 50 μm, for example. Positive electrode base material 11 may include a metal foil, for example. Positive electrode base material 11 may include at least one selected from the group consisting of aluminum (Al), manganese (Mn), titanium (Ti), iron (Fe), and chromium (Cr), for example. Positive electrode base material 11 may include an Al foil, an Al alloy foil, a Ti foil, an SUS foil, and/or the like, for example.

Between positive electrode base material 11 and positive electrode active material layer 12, an intermediate layer (not illustrated) may be formed. The intermediate layer does not include a positive electrode active material. The intermediate layer may have a thickness from 0.1 to 5 μm, for example. The intermediate layer may include a conductive material, an insulation material, a binder, and/or the like, for example. The conductive material and the binder are described below. The insulation material may include alumina, boehmite, aluminum hydroxide, and/or the like, for example.

Positive electrode active material layer 12 is placed on the surface of positive electrode base material 11. Positive electrode active material layer 12 may be placed on only one side of positive electrode base material 11. Positive electrode active material layer 12 may be placed on both sides of positive electrode base material 11. Positive electrode active material layer 12 may have a thickness from 10 to 1000 μm, or from 50 to 500 μm, or from 100 to 300 μm, for example. Positive electrode active material layer 12 includes a positive electrode active material. Positive electrode active material layer 12 may further include a conductive material, a binder, and the like, for example.

The conductive material may form an electron conduction path inside the positive electrode active material layer 12. The amount of the conductive material to be used may be, for example, from 0.1 to 10 parts by mass relative to 100 parts by mass of the positive electrode active material. The conductive material may include any component. The conductive material may include, for example, at least one selected from the group consisting of graphite, acetylene black (AB), Ketjenblack (registered trademark), vapor grown carbon fibers (VGCFs), carbon nanotubes (CNTs), and graphene flakes (GFs).

The binder is capable of fixing positive electrode active material layer 12 to positive electrode base material 11. The amount of the binder to be used may be, for example, from 0.1 to 10 parts by mass relative to 100 parts by mass of the positive electrode active material. The binder may include any component. The binder may include, for example, at least one selected from the group consisting of PVDF, PVDF-HFP, PTFE, CMC, PAA, PVA, PVP, polyoxyethylene alkyl ether, and derivatives of these.

Positive electrode active material layer 12 may further include an inorganic filler, an organic filler, a solid electrolyte, a surface modifier, a lubricant, a flame retardant, a protective agent, a flux, a coupling agent, an adsorbent, and/or the like, for example. Positive electrode active material layer 12 may include polyoxyethylene allylphenyl ether phosphate, zeolite, a silane coupling agent, MoS₂, WO₃, and/or the like, for example.

The positive electrode active material may be in particle form, for example. The positive electrode active material may include any component. The positive electrode active material may include a transition metal oxide, a polyanion compound, and/or the like, for example. In a single particle (positive electrode active material), the composition may be uniform, or may be non-uniform. For example, there may be a gradient in the composition from the surface of the particle toward the center. The composition may change contiguously, or may change non-contiguously (in steps).

The transition metal oxide may have any crystal structure. For example, the transition metal oxide may include a crystal structure that belongs to a space group R-3m and/or the like. For example, a compound represented by the general formula “LiMO₂” may have a crystal structure that belongs to a space group R-3m. The transition metal oxide may be represented by the following formula (3-1), for example.

Li₁₋ₐNiₓM₁₋ₓO₂ (3-1)

In the above formula (3-1), M may include, for example, at least one selected from the group consisting of Co, Mn, and Al. For example, the relationships of −0.5≤a≤0.5, 0<x≤1 may be satisfied.

For example, the relationship of −0.4≤a≤0.4, −0.3≤a≤0.3, −0.2≤a≤0.2, or −0.1≤a≤0.1 may be satisfied.

For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x≤1 may be satisfied.

The transition metal oxide may include, for example, at least one selected from the group consisting of LiCoO₂, LiMnO₂, LiNi_{0.9}Co_{0.1}O₂, LiNi_{0.9}Mn_{0.1}O₂, and LiNiO₂.

The transition metal oxide may be represented by the following formula (3-2), for example. A compound represented by the following formula (3-2) may also be called “NCM”.

Li₁₋ₐNiₓCo_{y}Mn_{z}O₂ (3-2)

In the above formula (3-2), the relationships of −0.5≤a≤0.5, 0<x<1, 0<y<1, 0<z<1, x+y+z=1 may be satisfied, for example.

For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied.

For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied.

For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCM may include, for example, at least one selected from the group consisting of LiNi_{1/3}Co_{1/3}Mn_{1/3}O₂, LiNi_{0.4}Co_{0.3}Mn_{0.3}O₂, LiNi_{0.3}Co_{0.4}Mn_{0.3}O₂, LiNi_{0.3}Co_{0.3}Mn_{0.4}O₂, LiNi_{0.5}Co_{0.2}Mn_{0.3}O₂, LiNi_{0.5}Co_{0.3}Mn_{0.2}O₂, LiNi_{0.5}Co_{0.4}Mn_{0.1}O₂, LiNi_{0.5}Co_{0.1}Mn_{0.4}O₂, LiNi_{0.6}Co_{0.2}Mn_{0.2}O₂, LiNi_{0.6}Co_{0.3}Mn_{0.1}O₂, LiNi_{0.6}Co_{0.1}Mn_{0.3}O₂, LiNi_{0.7}Co_{0.1}Mn_{0.2}O₂, LiNi_{0.7}Co_{0.2}Mn_{0.1}O₂, LiNi_{0.8}Co_{0.1}Mn_{0.1}O₂, and LiNi_{0.9}Co_{0.05}Mn_{0.05}O₂.

The transition metal oxide may be represented by the following formula (3-3), for example. A compound represented by the following formula (3-3) may also be called “NCA”.

Li₁₋ₐNiₓCo_{y}Al_{z}O₂ (3-3)

In the above formula (3-3), the relationships of −0.5≤a≤0.5, 0<x<1, 0<y<1, 0<z<1, x+y+z=1 may be satisfied, for example.

For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied.

For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied.

For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCA may include, for example, at least one selected from the group consisting of LiNi_{0.7}Co_{0.1}Al_{0.2}O₂, LiNi_{0.7}Co_{0.2}Al_{0.1}O₂, LiNi_{0.8}Co_{0.1}Al_{0.1}O₂, LiNi_{0.8}Co_{0.17}Al_{0.03}O₂, LiNi_{0.8}Co_{0.15}Al_{0.05}O₂, and LiNi_{0.9}Co_{0.05}Al_{0.05}O₂.

The positive electrode active material may include two or more NCMs and/or the like, for example. The positive electrode active material may include NCM (0.6≤x) and NCM (x<0.6), for example. “NCM (0.6≤x)” refers to a compound in which x (Ni ratio) in the above formula (3-2) is 0.6 or more. NCM (0.6≤x) may also be called “a high-nickel material”, for example. NCM (0.6≤x) includes LiNi_{0.8}Co_{0.1}Mn_{0.1}O₂ and/or the like, for example. “NCM (x<0.6)” refers to a compound in which x (Ni ratio) in the above formula (3-2) is less than 0.6. NCM (x<0.6) includes LiNi_{1/3}Co_{1/3}Mn_{1/3}O₂ and/or the like, for example. The mixing ratio (mass ratio) between NCM (0.6≤x) and NCM (x<0.6) may be “NCM (0.6≤x)/NCM (x<0.6)=9/1 to 1/9”, or “NCM (0.6≤x)/NCM (x<0.6)=9/1 to 4/6”, or “NCM (0.6≤x)/NCM (x<0.6)=9/1 to 3/7”, for example.

The positive electrode active material may include NCA and NCM, for example. The mixing ratio (mass ratio) between NCA and NCM may be “NCA/NCM=9/1 to 1/9”, “NCA/NCM=9/1 to 4/6”, or “NCA/NCM=9/1 to 3/7”, for example. Between NCA and NCM, the Ni ratio may be the same or may be different. The Ni ratio of NCA may be more than the Ni ratio of NCM. The Ni ratio of NCA may be less than the Ni ratio of NCM.

The transition metal oxide may include a crystal structure that belongs to a space group C2/m and/or the like, for example. The transition metal oxide may be represented by the following formula (3-4), for example.

Li₂MO₃ (3-4)

In the above formula (3-4), M may include, for example, at least one selected from the group consisting of Ni, Co, Mn, and Fe.

The positive electrode active material may include a mixture of LiMO₂ (space group R-3m) and Li₂MO₃ (space group C2/m), for example. The positive electrode active material may include a solid solution that is formed of LiMO₂ and Li₂MO₃ (Li₂MO₃-LiMO₂), and/or the like, for example.

The transition metal oxide may include a crystal structure that belongs to a space group Fd-3m, and/or the like, for example. The transition metal oxide may be represented by, for example, the following formula (3-5):

LiMn₂₋ₓMₓO₄ (3-5)

In the above formula (3-5), M may include, for example, at least one selected from the group consisting of Ni, Fe, and Zn. For example, the relationship of 0≤x≤2 may be satisfied.

LiM₂O₄ (space group Fd-3m) may include, for example, at least one selected from the group consisting of LiMn₂O₄ and LiMn_{1.5}Ni_{0.5}O₄. The positive electrode active material may include a mixture of LiMO₂ (space group R-3m) and LiM₂O₄ (space group Fd-3m), for example. The mixing ratio (mass ratio) between LiMO₂ (space group R-3m) and LiM₂O₄ (space group Fd-3m) may be “LiMO₂/LiM₂O₄=9/1 to 9/1”, “LiMO₂/LiM₂O₄=9/1 to 5/5”, or “LiMO₂/LiM₂O₄=9/1 to 7/3”, for example.

The polyanion compound may include a phosphoric acid salt (such as LiFePO₄ for example), a silicic acid salt, a boric acid salt, and/or the like, for example. The polyanion compound may be represented by the following formulae (3-6) to (3-9), for example.

LiMPO₄ (3-6)

Li₂₋ₓMPO₄F (3-7)

Li₂MSiO₄ (3-8)

LiMBO₃ (3-9)

In the above formulae (3-6) to (3-9), M may include, for example, at least one selected from the group consisting of Fe, Mn, Co. In the above formula (3-7), the relationship of 0≤x≤2 may be satisfied, for example.

The positive electrode active material may include a mixture of LiMO₂ (space group R-3m) and the polyanion compound, for example. The mixing ratio (mass ratio) between LiMO₂ (space group R-3m) and the polyanion compound may be “LiMO₂/(polyanion compound)=9/1 to 9/1”, “LiMO₂/(polyanion compound)=9/1 to 5/5”, or “LiMO₂/(polyanion compound)=9/1 to 7/3”, for example.

To the positive electrode active material, a dopant may be added. The dopant may be diffused throughout the entire particle, or may be locally distributed. For example, the dopant may be locally distributed on the particle surface. The dopant may be a substituted solid solution atom, or may be an intruding solid solution atom. The amount of the dopant to be added (the molar fraction relative to the total amount of the positive electrode active material) may be from 0.01 to 5%, or may be from 0.1 to 3%, or may be from 0.1 to 1%, for example. A single type of dopant may be added, or two or more types of dopant may be added. The two or more dopants may form a complex.

The dopant may include, for example, at least one selected from the group consisting of B, C, N, a halogen, Si, Na, Mg, Al, Mn, Co, Cr, Sc, Ti, V, Cu, Zn, Ga, Ge, Se, Sr, Y, Zr, Nb, Mo, In, Pb, Bi, Sb, Sn, W, La, Ce, Pr, Nd, Pm, Sm, Eu, Gd, Tb, Dy, Ho, Er, Tm, Yb, Lu, and an actinoid.

For example, to NCA, a combination of “Zr, Mg, W, Sm”, a combination of “Ti, Mn, Nb, Si, Mo”, or a combination of “Er, Mg” may be added. For example, to NCM, Ti may be added. For example, to NCM, a combination of “Zr, W”, a combination of “Si, W”, or a combination of “Zr, W, Al, Ti, Co” may be added.

Positive electrode 10 may include a composite particle. The composite particle includes a core particle and a shell layer. The core particle includes a positive electrode active material. The shell layer covers at least part of the surface of the core particle. The shell layer may have a thickness from 1 to 3000 nm, or from 5 to 2000 nm, or from 10 to 1000 nm, or from 10 to 100 nm, or from 10 to 50 nm, for example. The thickness of the shell layer may be measured in an SEM image of a cross section of the particle, and/or the like, for example. More specifically, the composite particle is embedded in a resin material to prepare a sample. With the use of an ion milling apparatus, a cross section of the sample is exposed. For example, an ion milling apparatus with the trade name “ArBlade (registered trademark) 5000” manufactured by Hitachi High-Technologies (or a similar product) may be used. The cross section of the sample is examined by an SEM. For example, an SEM apparatus with the trade name “SU8030” manufactured by Hitachi High-Technologies (or a similar product) may be used. For each of ten composite particles, the thickness of the shell layer is measured in twenty fields of view. The arithmetic mean of a total of 200 thickness measurements is used.

The ratio of the part of the surface of the core particle covered by the shell layer is also called “a covering rate”. The covering rate may be 1% or more, or 10% or more, or 30% or more, or 50% or more, or 70% or more, for example. The covering rate may be 100% or less, or 90% or less, or 80% or less, for example.

For example, the covering rate may be measured by XPS (X-ray Photoelectron Spectroscopy). For example, an XPS apparatus with the trade name “PHI X-tool” manufactured by ULVAC-PHI (or a similar product) may be used. A sample (powder) is loaded in the XPS apparatus. Narrow scan analysis is carried out. The measurement data is processed with an analysis software. For example, an analysis software with the trade name “MulTiPak” manufactured by ULVAC-PHI (or a similar product) may be used. The measurement data is analyzed to detect a plurality of types of elements. From the area of each peak, the ratio of the detected element is determined. By the following equation (3-10), the covering rate is determined.

$$θ = \{ {I}_{1} / ( {I}_{0} + {I}_{1} ) \} \times 100 \qquad ( 3 - 10 )$$

θ: Covering rate [%]
I₀: Ratio of element attributable to core particle
I₁: Ratio of element attributable to shell layer
For example, when the core particle includes NCM, I₀ represents the total ratio of the elements “Ni, Co, Mn”. For example, when the core particle includes NCA, I₀ represents the total ratio of the elements “Ni, Co, Al”. For example, when the shell layer includes P and B, I₁ represents the total ratio of the elements “P, B”.

The shell layer may include any component. The shell layer may include an elementary substance, organic matter, an inorganic acid salt, an organic acid salt, a hydroxide, an oxide, a carbide, a nitride, a sulfide, a halide, and/or the like, for example. The shell layer may include, for example, at least one selected from the group consisting of B, Al, W, Zr, Ti, Co, F, lithium compound (such as Li₂CO₃, LiHCO₃, LiOH, Li₂O, for example), tungsten oxide (such as WO₃, for example), titanium oxide (such as TiO₂, for example), zirconium oxide (such as ZrO₂, for example), boron oxide, boron phosphate (such as BPO₄, for example), aluminum oxide (such as Al₂O₃, for example), boehmite, aluminum hydroxide, phosphoric acid salt [such as Li₃PO₄, (NH₄)₃PO₄, AlPO₄, for example], boric acid salt (such as Li₂B₄O₇, LiBO₃, for example), polyacrylic acid salt (such as Li salt, Na salt, NH₄ salt), acetic acid salt (such as Li salt, for example), CMC (such as Na salt, Li salt, NH₄ salt), LiNbO₃, Li₂TiO₃, and Li-containing halide (such as LiAlCl₄, LiTiAlF₆, LiYBr₆, LiYCl₆, for example).

Each of “a hollow particle” and “a solid particle” is a secondary particle (an aggregate of primary particles). In a cross-sectional image of “a hollow particle”, the proportion of the area of the central cavity relative to the entire cross-sectional area of the particle is 30% or more. The proportion of the cavity in the hollow particle may be 40% or more, or 50% or more, or 60% or more, for example. In a cross-sectional image of “a solid particle”, the proportion of the area of the central cavity relative to the entire cross-sectional area of the particle is less than 30%. The proportion of the cavity in the solid particle may be 20% or less, or 10% or less, or 5% or less, for example. The positive electrode active material may be hollow particles, or may be solid particles. A mixture of hollow particles and solid particles may be used. The mixing ratio (mass ratio) between hollow particles and solid particles may be “(hollow particles)/(solid particles)=1/9 to 9/1”, or “(hollow particles)/(solid particles)=2/8 to 8/2”, or “(hollow particles)/(solid particles)=3/7 to 7/3”, or “(hollow particles)/(solid particles)=4/6 to 6/4”, for example.

The positive electrode active material may have a unimodal particle size distribution (based on the number), for example. The positive electrode active material may have a multimodal particle size distribution, for example. The positive electrode active material may have a bimodal particle size distribution, for example. That is, the positive electrode active material may include “large particles” and “small particles”. When the particle size distribution is bimodal, the particle size corresponding to the peak top of the larger particle size is regarded as the particle size of the large particles (d_{L}). The particle size corresponding to the peak top of the smaller particle size is regarded as the particle size of the small particles (d_{S}). The particle size ratio (d_{L}/d_{S}) may be from 2 to 10, or from 2 to 5, or from 2 to 4, for example. d_{L} may be from 8 to 20 μm, or from 8 to 15 μm, for example. d_{S} may be from 1 to 10 μm, or from 1 to 5 μm, for example.

For example, with the use of a waveform analysis software, peak separating processing may be carried out for the particle size distribution. The ratio between the peak area of the large particles (S_{L}) and the peak area of the small particles (S_{S}) may be “S_{L}/S_{S}=1/9 to 9/1”, or “S_{L}/S_{S}=5/5 to 9/1”, or “S_{L}/S_{S}=7/3 to 9/1”, for example.

The number-based particle size distribution is measured by a microscope method. From positive electrode active material layer 12, a plurality of cross-sectional samples are taken. The cross-sectional sample may include a cross section vertical to the surface of positive electrode active material layer 12, for example. By ion milling and/or the like, for example, cleaning is carried out to the side that is to be observed. By SEM, the cross-sectional sample is examined. The magnification for the examination is adjusted in such a way that 10 to 100 particles are contained within the examination field of view. The Feret diameters of all the particles in the image are measured. “Feret diameter” refers to the distance between two points located farthest apart from each other on the outline of the particle. The plurality of the cross-sectional samples are examined to obtain a total of 1000 or more Feret diameters. From the 1000 or more Feret diameters, number-based particle size distribution is created.

The bimodal particle size distribution may be formed by two types of particles mixed together. These two types of particles have different particle size distributions. For example, the two types of particles may have different D50. For example, the large particles may have a D50 from 8 to 20 μm, or from 8 to 15 μm. For example, the small particles may have a D50 from 1 to 10 μm, or from 1 to 5 μm. The ratio of the D50 of the large particles to the D50 of the small particles may be from 2 to 10, or from 2 to 5, or from 2 to 4, for example. The mixing ratio (mass ratio) between the large particles and the small particles may be “(large particles)/(small particles)=1/9 to 9/1”, or “(large particles)/(small particles)=5/5 to 9/1”, or “(large particles)/(small particles)=7/3 to 9/1”, for example.

The large particles and the small particles may have the same composition, or may have different compositions. For example, the large particles may be NCA and the small particles may be NCM. For example, the large particles may be NCM (0.6≤x) and the small particles may be NCM (x<0.6).

### <Electrolyte Solution>

The electrolyte solution is a liquid electrolyte. The electrolyte solution includes Li ions. The electrolyte solution may include a solute and a solvent, for example.

The concentration of the solute may be from 0.5 to 1 mol/L, or from 1 to 1.5 mol/L, or from 1.5 to 2 mol/L, or from 2 to 2.5 mol/L, or from 2.5 to 3 mol/L, for example. The solute includes a supporting salt (a Li salt). The solute may include an inorganic acid salt, an imide salt, an oxalato complex, a halide, and/or the like, for example. The solute may include, for example, at least one selected from the group consisting of LiPF₆, LiBF₄, LiClO₄, LiAsF₆, LiSbF₆, LiN(SO₂F)₂ which has the common name “LiFSI”, LiN(SO₂CF₃)₂ which has the common name “LiTFSI”, LiB(C₂O₄)₂ which has the common name “LiBOB”, LiBF₂(C₂O₄) which has the common name “LiDFOB”, LiPF₂(C₂O₄)₂ which has the common name “LiDFOP”, LiPO₂F₂, FSO₃Li, LiI, LiBr, and derivatives of these.

The electrolyte solution may include an ether-based solvent, for example. The solvent may include, for example, at least one selected from the group consisting of tetrahydrofuran (THF), 1,4-dioxane (DOX), 1,3-dioxolane (DOL), 1,2-dimethoxyethane (DME), 1,2-diethoxyethane (DEE), ethylglyme, triglyme, tetraglyme, hydrofluoroether (HFE), and derivatives of these.

HFE may include, for example, at least one selected from the group consisting of a difluoromethyl group, a 2,2-difluoroethyl group, a 2,2,2-trifluoroethyl group, a 1,1,2,2-tetrafluoroethyl group, a 2,2,3,3,3-pentafluoropropyl group, a 2,2,3,3-tetrafluoropropyl group, a 1,1,1,3,3,3-hexafluoroisopropyl group, a 1,1,2,3,3,3-hexafluoropropyl group, a 2,2,3,3,4,4,4-heptafluorobutyl group, a 2,2,3,3,4,4-hexafluorobutyl group, and a 2,2,3,3,4,4,5,5-octafluoropentyl group.

HFE may include, for example, at least one selected from the group consisting of 1,1,2,2-tetrafluoroethyl 2,2,3,3-tetrafluoropropyl ether, 2,2,2-trifluoroethyl ether, difluoromethyl 2,2,3,3-tetrafluoropropyl ether, 2,2,3,3-tetrafluoropropyl 1,1,2,3,3,3-hexafluoropropyl ether, 2,2,3,3,4,4,5,5-octafluoropentyl 1,1,2,2-tetrafluoroethyl ether, and derivatives of these.

The electrolyte solution may include a carbonate-based solvent (a carbonate-ester-based solvent), for example. The solvent may include a cyclic carbonate, a chain carbonate, a fluorinated carbonate, and/or the like, for example. The solvent may include, for example, at least one selected from the group consisting of ethylene carbonate (EC), propylene carbonate (PC), butylene carbonate (BC), dimethyl carbonate (DMC), diethyl carbonate (DEC), ethyl methyl carbonate (EMC), monofluoroethylene carbonate (FEC), difluoroethylene carbonate, 4,4-difluoroethylene carbonate, trifluoroethylene carbonate, perfluoroethylene carbonate, fluoropropylene carbonate, difluoropropylene carbonate, and derivatives of these.

The solvent may include a cyclic carbonate (such as EC, PC, FEC) and a chain carbonate (such as EMC, DMC, DEC). The mixing ratio between the cyclic carbonate and the chain carbonate (volume ratio) may be “(cyclic carbonate)/(chain carbonate)=1/9 to 4/6”, or “(cyclic carbonate)/(chain carbonate)=2/8 to 3/7”, or “(cyclic carbonate)/(chain carbonate)=3/7 to 4/6”, for example.

The solvent may include a cyclic carbonate (such as EC, PC) and a fluorinated cyclic carbonate (such as FEC). The mixing ratio between the cyclic carbonate and the fluorinated cyclic carbonate (volume ratio) may be “(cyclic carbonate)/(fluorinated cyclic carbonate)=99/1 to 90/10”, or “(cyclic carbonate)/(fluorinated cyclic carbonate)=9/1 to 1/9”, or “(cyclic carbonate)/(fluorinated cyclic carbonate)=9/1 to 7/3”, or “(cyclic carbonate)/(fluorinated cyclic carbonate)=3/7 to 1/9”, for example.

The solvent may include EC, FEC, EMC, DMC, and DEC, for example. The volume ratio of these components may satisfy the relationship represented by the following equation (4-1), for example.

$${V}_{EC} + {V}_{FEC} + {V}_{EMC} + {V}_{DMC} + {V}_{DEC} = 10 \qquad ( 4 - 1 )$$

In the above equation (4-1), V_{EC}, V_{FEC}, V_{EMC}, V_{DMC}, and V_{DEC} represent the volume ratios of EC, FEC, EMC, DMC, and DEC, respectively.

For example, the relationships of 1≤V_{EC}≤4, 0≤V_{FEC}≤3, V_{EC}+V_{FEC}≤4, 0≤V_{EMC}≤9, 0≤V_{DMC}≤9, 0≤V_{DEC}≤9, and 6≤V_{EMC}+V_{DMC}+V_{DEC}≤9 may be satisfied.

In the above equation (4-1),
the relationship of 1≤V_{EC}≤2 or 2≤V_{EC}≤3 may be satisfied, for example;
the relationship of 1≤V_{FEC}≤2 or 2≤V_{FEC}≤4 may be satisfied, for example;
the relationship of 3≤V_{EMC}≤4 or 6≤V_{EMC}≤8 may be satisfied, for example;
the relationship of 3≤V_{DMC}≤4 or 6≤V_{DMC}≤8 may be satisfied, for example; and
the relationship of 3≤V_{DEC}≤4 or 63V_{DEC}≤8 may be satisfied, for example.

The solvent may have a composition of “EC/EMC=3/7”, “EC/DMC-3/7”, “EC/FEC/DEC=1/2/7”, “EC/DMC/EMC=3/4/3”, “EC/DMC/EMC-3/3/4”, “EC/FEC/DMC/EMC=2/1/4/3”, “EC/FEC/DMC/EMC=1/2/4/3”, “EC/FEC/DMC/EMC=2/1/3/4”, “EC/FEC/DMC/EMC=1/2/3/4” (volume ratio), and/or the like, for example.

The electrolyte solution may include any additive. The amount to be added (the mass fraction to the total amount of the electrolyte solution) may be from 0.01 to 5%, or from 0.05 to 3%, or from 0.1 to 1%, for example. The additive may include an SEI (Solid Electrolyte Interphase) formation promoter, an SEI formation inhibitor, a gas generation agent, an overcharging inhibitor, a flame retardant, an antioxidant, an electrode-protecting agent, a surfactant, and/or the like, for example.

The additive may include, for example, at least one selected from the group consisting of vinylene carbonate (VC), vinylethylene carbonate (V_{EC}), 1,3-propane sultone (PS), tert-amylbenzene, 1,4-di-tert-butylbenzene, biphenyl (BP), cyclohexylbenzene (CHB), ethylene sulfite (ES), propane sultone (PS), ethylene sulfate (DTD), γ-butyrolactone, phosphazene compound, carboxylate ester [such as methyl formate (MF), methyl acetate (MA), methyl propionate (MP), diethyl malonate (DEM), for example], fluorobenzene (such as monofluorobenzene (FB), 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene, for example), fluorotoluene (such as 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, octafluorotoluene, for example), benzotrifluoride (such as benzotrifluoride, 2-fluorobenzotrifluoride, 3-fluorobenzotrifluoride, 4-fluorobenzotrifluoride, 2-methylbenzotrifluoride, 3-methylbenzotrifluoride, 4-methylbenzotrifluoride, for example), fluoroxylene (such as 3-fluoro-o-xylene, 4-fluoro-o-xylene, 2-fluoro-m-xylene, 5-fluoro-m-xylene, for example), sulfur-containing heterocyclic compound (such as benzothiazole, 2-methylbenzothiazole, tetrathiafulvalene, for example), nitrile compound (such as adiponitrile, succinonitrile, for example), phosphate (such as trimethyl phosphate, triethyl phosphate, for example), carboxylic anhydride (such as acetic anhydride, propionic anhydride, oxalic anhydride, succinic anhydride, maleic anhydride, phthalic anhydride, benzoic anhydride, for example), alcohol (such as methanol, ethanol, n-propyl alcohol, ethylene glycol, diethylene glycol monomethyl ether, for example), and derivatives of these.

The components described above as the solute and the solvent may be used as the additive (a trace component). The additive may include, for example, at least one selected from the group consisting of LiBF₄, LiFSI, LiTFSI, LiBOB, LiDFOB, LiDFOP, LiPO₂F₂, FSO₃Li, LiI, LiBr, HFE, DOX, PC, FEC, and derivatives of these.

The electrolyte solution may include an ionic liquid. The electrolyte solution may include, for example, at least one selected from the group consisting of a sulfonium salt, an ammonium salt, a pyridinium salt, a piperidinium salt, a pyrrolidinium salt, a morpholinium salt, a phosphonium salt, an imidazolium salt, and derivatives of these.

Battery 100 may include a gelled electrolyte. The gelled electrolyte includes an electrolyte solution and a polymer material. The polymer material may form a polymer matrix. The polymer material may include, for example, at least one selected from the group consisting of PVdF, PVdF-HFP, PAN, PVdF-PAN, polyethylene oxide (PEO), polyethylene glycol (PEG), and derivatives of these.

### <Separator>

Separator 30 is electrically insulating. Separator 30 may include, for example, at least one selected from the group consisting of a resin film, an inorganic particle layer, and an organic particle layer. Separator 30 may include a resin film and an inorganic particle layer, for example.

The resin film is porous. The resin film may include a microporous film, a nonwoven fabric, and/or the like, for example. The resin film includes a resin skeleton. The resin skeleton may be contiguous in mesh form, for example. Gaps in the resin skeleton form pores. The resin film allows the electrolyte solution to permeate therethrough. The resin film may have an average pore size of 1 μm or less, for example. The resin film may have an average pore size from 0.01 to 1 μm, or from 0.1 to 0.5 μm, for example. “Average pore size” may be measured by mercury porosimetry. The resin film may have a Gurley value from 50 to 250 s/100 cm³, for example. “Gurley value” may be measured by a Gurley test method.

The resin film may include, for example, at least one selected from the group consisting of an olefin-based resin, a urethane-based resin, a polyamide-based resin, a cellulose-based resin, a polyether-based resin, an acrylic-based resin, a polyester-based resin, and the like. The resin film may include, for example, at least one selected from the group consisting of polyethylene (PE), polypropylene (PP), polyamide (PA), polyamide-imide (PAI), polyimide (PI), aromatic polyamide (aramid), and polyphenylene ether (PPE), and derivatives of these. The resin film may be formed by stretching, phase separation, and/or the like, for example. The resin film may have a thickness from 5 to 50 μm, or from 10 to 25 μm, for example.

The resin film may have a monolayer structure. The resin film may consist of a PE layer, for example. A skeleton of a PE layer is formed of PE. The PE layer may have shut-down function. The resin film may have a multilayer structure, for example. The resin film may include a PP layer and a PE layer, for example. A skeleton of a PP layer is formed of PP. The resin film may have a three-layer structure, for example. The resin film may be formed by stacking a PP layer, a PE layer, and a PP layer in this order, for example. The thickness of the PE layer may be from 5 to 20 μm, for example. The thickness of the PP layer may be from 3 to 10 μm, for example.

The inorganic particle layer may be formed on the surface of the resin film. The inorganic particle layer may be formed on only one side of the resin film, or may be formed on both sides of the resin film. The inorganic particle layer may be formed on the side facing positive electrode 10, or may be formed on the side facing negative electrode 20.

The inorganic particle layer is porous. The inorganic particle layer includes inorganic particles. The inorganic particles may also be called “an inorganic filler”. Gaps between the inorganic particles form pores. The inorganic particle layer may have a thickness from 0.5 to 10 μm, or from 1 to 5 μm, for example. The inorganic particles may include a heat-resistant material, for example. The inorganic particle layer that includes a heat-resistant material is also called “HRL (Heat Resistance Layer)”. The inorganic particles may include at least one selected from the group consisting of boehmite, alumina, zirconia, titania, magnesia, silica, and the like. The inorganic particles may have any shape. The inorganic particles may be spherical, rod-like, plate-like, fibrous, and/or the like, for example. The inorganic particles may have a D50 from 0.1 to 10 μm, or from 0.5 to 3 μm, for example. The inorganic particle layer may further include a binder. The binder may include, for example, at least one selected from the group consisting of an acrylic-based resin, a polyamide-based resin, a fluorine-based resin, an aromatic-polyether-based resin, and a liquid-crystal-polyester-based resin, and the like.

Separator 30 may include an organic particle layer, for example. Separator 30 may include an organic particle layer instead of the resin film, for example. Separator 30 may include an organic particle layer instead of the inorganic particle layer, for example. Separator 30 may include both the resin film and an organic particle layer. Separator 30 may include both the inorganic particle layer and an organic particle layer. Separator 30 may include the resin film, the inorganic particle layer, and an organic particle layer.

The organic particle layer may have a thickness from 0.1 to 50 μm, or from 0.5 to 20 μm, or from 0.5 to 10 μm, or from 1 to 5 μm, for example. The organic particle layer includes organic particles. The organic particles may also be called “an organic filler”. The organic particles may include a heat-resistant material. The organic particles may include, for example, at least one selected from the group consisting of PE, PP, PTFE, PI, PAI, PA, aramid, and the like. The organic particles may be spherical, rod-like, plate-like, fibrous, and/or the like, for example. The organic particles may have a D50 from 0.1 to 10 μm, or from 0.5 to 3 μm, for example.

Separator 30 may include a mixed layer, for example. The mixed layer includes both inorganic particles and organic particles.

### <Battery Configuration Example>

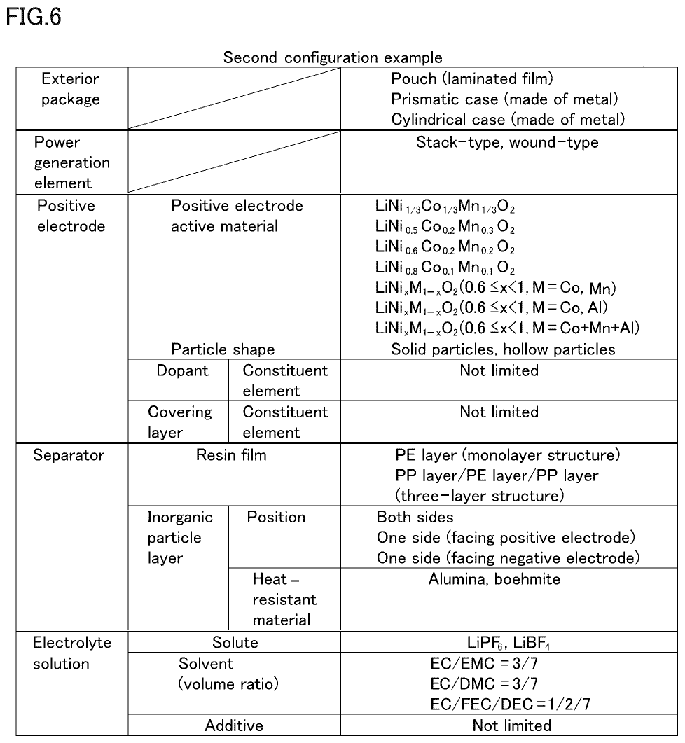

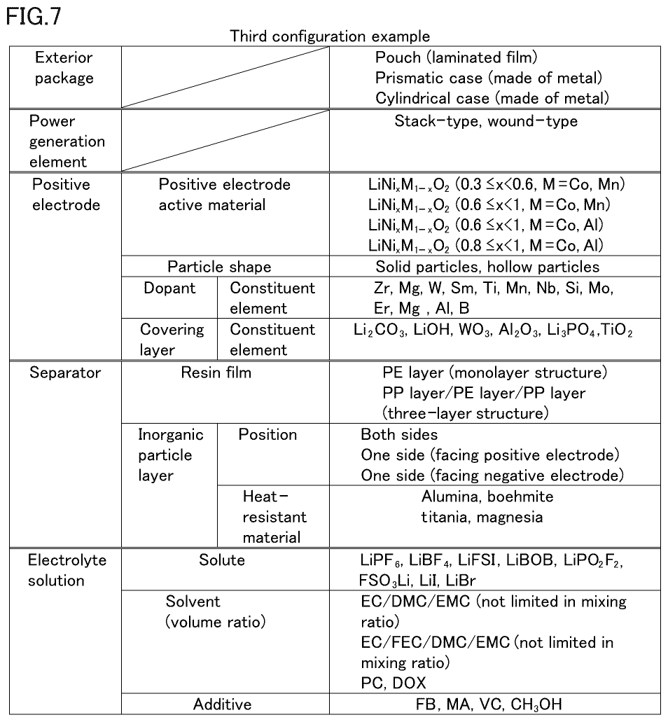

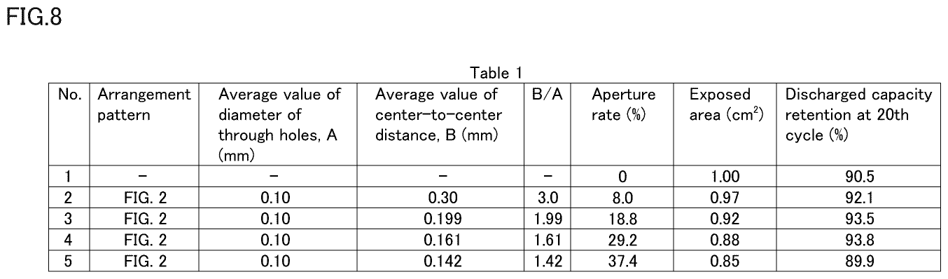

FIG. 5 is a first configuration example. FIG. 6 is a second configuration example. FIG. 7 is a third configuration example. In the table in each figure, when a plurality of materials are described in a single cell, this description is intended to mean one of them as well as a combination of them. For example, when materials “α, β, γ” are described in a single cell, this description is intended to mean “at least one selected from the group consisting of α, β, and γ”.

In the present embodiment, as long as current collector 21 has the configuration according to above-mentioned embodiment where it has a plurality of through holes and, also, as long as negative electrode 20 uses a lithium metal dissolution/deposition reaction, the other configurations (such as the combination of the positive electrode, the separator, and the electrolyte solution, and the like) are not particularly limited. For example, certain elements may be extracted from the first configuration example, the second configuration example, and the third configuration example, and they may be combined together in a freely-selected manner.

### <Examples of Battery Production>

In the present embodiment, as long as current collector 21 has the configuration according to above-mentioned embodiment where it has a plurality of through holes and, also, as long as negative electrode 20 uses a lithium metal dissolution/deposition reaction, the method of producing the lithium secondary battery is not particularly limited. An example may be a production method that comprises preparing current collector 21; assembling the positive electrode, the separator, the negative electrode, and the electrolyte solution into a lithium secondary battery precursor; and charging the lithium secondary battery precursor to let lithium metal be deposited on the negative electrode. By the step of depositing lithium metal, Li metal layer 23 can be formed.

### EXAMPLES

### <Production of Test Batteries>

Test batteries (anode-free batteries) according to Nos. 1 to 5 were produced in the procedure described below. For example, hereinafter, “the test battery according to No. 1” may be simply referred to as “No. 1” and the like.

### No. 1

NCM as an active material, PVdF as a binder, and a conductive aid were mixed together, and the resulting mixture was transferred to a vessel, followed by stirring with a THINKY MIXER named Awatori Rentaro (2000 rpm, 1 minute) in 3 to 4 divided sessions. Subsequently, while the viscosity was being checked, N-methylpyrrolidone (NMP) was added thereto and the content was stirred into uniformity (2000 rpm, 5 minutes). As needed, additional NMP was added and stirred (2000 rpm, 2 minutes). In this way, a slurry was obtained.

As a positive electrode base material, an aluminum foil (thickness, 16 μm) was prepared. To the aluminum foil (thickness, 16 μm), the slurry obtained in the above manner was applied with the use of a doctor blade. A doctor blade with a gap of 350, 375, 400 μm was used. The target mass per unit area, which was the weight of the coating after the solvent was dried, was about 23 mg/cm². Subsequently, roll pressing was carried out to adjust the density at 2.4 to 2.9 g/cc. Subsequently, the resultant was cut into the size of a coin cell (about 1.5 cm²) or a laminated cell (about 27 cm²), and thereby a positive electrode was prepared.

As a separator, a resin film (thickness, 20 μm) was prepared. The resin film included PP/PE.

As a negative electrode, a copper foil (thickness, 15 μm) was prepared. The copper foil was used as a current collector, with no machining carried out thereto for through hole formation and with metal coating carried out thereto.

The positive electrode, the separator, and the negative electrode were stacked in this order, and thereby a power generation element was formed. The resulting power generation element was placed inside an exterior package. Into the exterior package, an electrolyte solution was injected. The composition of the electrolyte solution was as described below.

### Composition of Electrolyte Solution

Solute: LiTFSI (1 mol/L)
Solvent: PC/FEC=7/3 (volume ratio)

After the electrolyte solution was injected, the exterior package was hermetically sealed. In this manner, a test battery was produced.

### Nos. 2 to 5

As a negative electrode, a copper foil (thickness, 15 μm) was prepared. A plurality of through holes were formed in the copper foil by laser machining in the arrangement pattern illustrated in FIG. 2, and the resultant was used as a current collector. Table 1 of FIG. 8 shows the pattern of arrangement of the plurality of through holes of the current collector, measured values for the shape of the through holes, and values calculated from the measured values for the shape of the through holes. The measured values for the shape of the through holes given in the table are A (mm), which is the average value of the diameter (a (mm)), as well as B (mm), which is the average value of the center-to-center distance (b (mm)). The measured values given in Table 1 of FIG. 8 are values that were obtained by measurement and calculation from an SEM image of one of the surfaces of the current collector. The values calculated from the measured values given in the table are the B/A values, the aperture rate (%), and the exposed area (cm²) per 1 cm² of the surface. The copper foil with a plurality of through holes was used as a current collector, and except this, the same manner as for No. 1 was adopted to produce a test battery.

### <Evaluation>

Cycle testing was carried out under the conditions described below.
1. Rest: 60 min
2. CCCV charging: (¼) C (cutoff current, ( 1/100) C)
3. Rest: 5 minutes
4. CC discharging: (¼) C, 3.0 V
5. Rest: 5 min

Number of repetition of the cycle consisting of “2.” to “5.”: 20

The discharged capacity at each cycle was divided by the discharged capacity at the first cycle, and thereby the discharged capacity retention at each cycle was determined. The discharged capacity retention at each cycle is expressed in percentage.

### <Results>

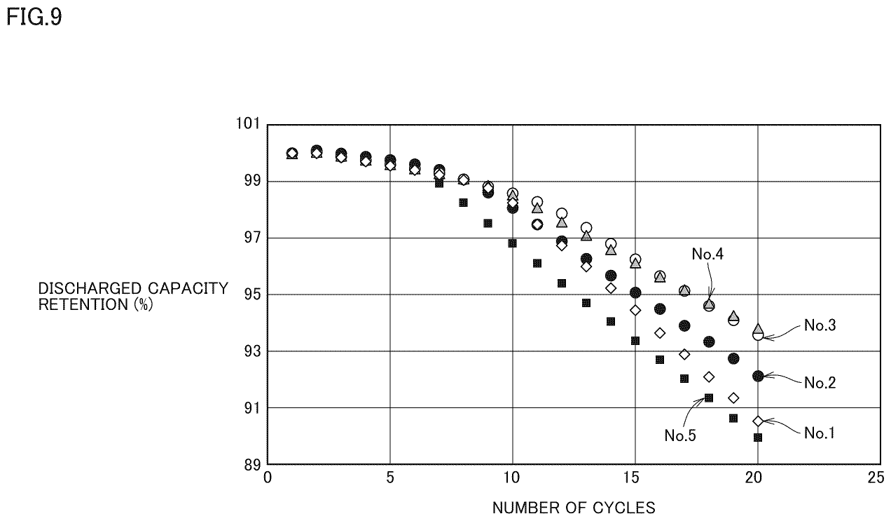

Table 1 (of FIG. 8) shows the discharged capacity retention at the 20th cycle. In FIG. 9, the horizontal axis indicates the number of cycles, and the vertical axis indicates the discharged capacity retention for each number of cycles. The higher the discharged capacity retention is, the better the cycle endurance is considered to be. No. 2, No. 3, and No. 4 had improved cycle endurance, as compared to No. 1 (without through holes) and No. 5 (where the plurality of through holes do not satisfy the condition of the expression (1)). From FIG. 8 and FIG. 9, it is understood that the discharged capacity retention tends to be enhanced when B/A is within the range of 1.5 to 3.0.

From the discharged capacity retention at the 20th cycle given in Table 1 (FIG. 8), it is understood that the discharged capacity retention at the 20th cycle tends to be enhanced when the aperture rate of the current collector is from 5.0 to 35.0%. From the discharged capacity retention at the 20th cycle given in Table 1 (FIG. 8), it is understood that the discharged capacity retention at the 20th cycle tends to be enhanced when the exposed area of the current collector per 1 cm² of the surface is from 0.86 to 0.99 cm².

What is claimed is:

1. A lithium secondary battery comprising:
a positive electrode;
a separator;
a negative electrode; and
an electrolyte solution, and using a lithium metal dissolution/deposition reaction as a reaction at the negative electrode, wherein
the negative electrode includes a current collector,
the current collector has a thickness from 10 to 20 μm,
the current collector has a plurality of through holes, and
the through holes satisfy relationships of an expression (1) and an expression (2):
$$1.5 \leq B / A \leq 3. \qquad ( 1 )$$
$$0.05 \leq A \leq 0.18 \qquad ( 2 )$$
where a diameter of each of the through holes at a surface of the current collector is defined as a (mm), a center-to-center distance between each of the through holes and another through hole closest thereto is defined as b (mm), an average value of the diameter a (mm) is defined as A (mm), and an average value of the center-to-center distance b (mm) is defined as B (mm).

2. The lithium secondary battery according to claim 1, wherein the current collector is copper or copper alloy.

3. The lithium secondary battery according to claim 1, wherein an aperture rate of the surface of the current collector is from 5.0 to 35.0%.

4. The lithium secondary battery according to claim 1, wherein an exposed area per 1 cm² of the surface of the current collector is from 0.86 to 0.99 cm².

5. The lithium secondary battery according to claim 1, wherein the current collector is a copper foil or a copper alloy foil, an aperture rate of the surface is from 5.0 to 35.0%, and an exposed area per 1 cm² of the surface is from 0.86 to 0.99 cm².

6. A method of producing the lithium secondary battery according to claim 1, the method comprising:
preparing the current collector;
assembling the positive electrode, the separator, the negative electrode, and the electrolyte solution into a lithium secondary battery precursor; and
charging the lithium secondary battery precursor to let lithium metal be deposited on the negative electrode.
